(19) United States
(12) Patent Application Publication
(10) Pub. No.: US 2025/0348659 A1
(43) Pub. Date: Nov. 13, 2025

(54) METHODS AND APPLICATIONS FOR GENERATING CITATIONS FOR MACHINE-GENERATED CONTENT

(71) Applicant: Adeia Imaging LLC, San Jose, CA (US)

(72) Inventors: Ning Xu, Irvine, CA (US); Serhad Doken, Bryn Mawr, PA (US)

(21) Appl. No.: 18/657,677

(22) Filed: May 7, 2024

(51) Int. Cl. G06F 40/169; G06F 21/16; G06V 10/70; G06V 30/18

(52) U.S. Cl. CPC G06F 40/169; G06F 21/16; G06V 10/70; G06V 30/18143

(57) ABSTRACT

A citation for output content that is generated by a trained generative machine learning (ML) model is disclosed. A content database is filtered based on a text prompt embedding generated based on the same text prompt input to the ML model to generate the output content. Further filtering may be performed using an output content embedding generated based on the output content generated by the ML model. A base content item is then estimated as being similar to the output content generated by the ML model by filtering the content list using component/content features generated based on the output content. A similarity score is generated and the citation identifying the base content item is provided to the ML model. In response to determining that the similarity meets a first threshold similarity criterion, an alternative output content may be generated with or without further user input.

### BACKGROUND

The present disclosure relates to automated generation of a citation to a base content item that may have been used to derive an output content item. The output content item may be, for example, text-to-image output content generated by a trained generative machine learning (ML) model. The present disclosure also relates to remediation techniques in some cases, such as where there is a degree of similarity between the output content item generated by the ML model and the base content item that may infringe or violate rights in the base content item.

### SUMMARY

The proliferation of generative AI (Artificial Intelligence) tools that create content from user prompts has raised unique technological problems and challenges. Generative AI tools generally create output content using trained machine learning (ML) models that often draw from, or are inspired by, one or more base content items that have been used to train the ML models and/or may have otherwise be provided as an input to generate the output content. However, generative AI tools typically do not provide information of which base content item(s) the ML model used (or did not use) to generate the output content, and/or the extent of the use or incorporation of the base content to generate the output content. It may be desirable to identify some designation about the base content that the ML model used for generating the output content. A related technological problem is that the output content generated by the ML model may have one or more portions that appear similar to (or sound like or otherwise resemble) the base content, and thus may run afoul of copyright laws, industry practices, and/or other protections. For this reason, the output content may be unfit or unauthorized for some uses after its generation by the ML model, or, at least, the suitability of the output content may be in doubt. In a similar vein, a user of the output content may not know the extent of the originality of the output content-the technological sophistication of the ML model may be assessed, at least in part, based on how creative or original the ML model is in generating output content compared with the base content items that it used.

Another technological problem is that even if a user were to know the base content used for the output content, and roughly the extent of incorporation of the base content in the output content, the user may not be able to remedy in an automated way excessive or unoriginal “borrowing” from the base content. For example, even if the user were to recognize the base content that may have served as inspiration or a basis for the output content, and then to estimate correctly that there is an overlap between the output content and the base content, the user may not be able identify with accuracy what portion(s) of the output content are similar to the base content. Also, even if the user were to recognize the base content inspiration for a piece of output content, and to estimate correctly that there is some overlap between the output content and the base content, the user may be unable to effectively or efficiently remedy or alter the output content to avoid encroaching on or infringing rights of an original author or creator of the base content.

A technological solution to the above-noted technological problem and to other problems may be provided by one or more aspects of the present disclosure. According to an aspect of the disclosure, a system (e.g., a citator or content citation server or system) searches one or more content databases and generates a content citation for the output content generated by the ML model. The search may filter a content database based at least in part on a text prompt used by the ML model to generate the output content. In an embodiment, the search may filter content items in the content database using a text prompt embedding generated based on the same text prompt that was input to the ML model and used to generate the output content. The text prompt embedding may be generated by an additional ML model (e.g., not the same ML model as the generative ML model, but that may be incorporated into an overall generative AI/ML system). This ML model may generate the text prompt embedding based on the same text prompt that was provided to the generative ML model that created the output content. If the ML model generates visual output content, the system may generate a visual citation that references base images (or portions thereof) that have sufficiently similar style, components, and/or features as one or more portions of the output content image created by the ML model.

In some embodiments, a content citation server or system may list or identify one or more of the title and series or volume, the author, composer, artist, singer, band, orchestra, director, producer, arranger, cinematographer, choreographer, or the like (sometimes referred to as a human creator) of the one or more base content items that are similar to the output content generated by the ML model. The ML model may be part of a generative AI system with a range of functions.

The content citation generated by the citator may also indicate the database or location, year or date of creation, production, release, or recording in a medium (sometimes referred to as “source”), and the copyright owner, studio, record label, or physical custodian of the base content item(s). The content citation may also include a URL address, physical address, database or other contact information (sometimes referred to as “source”) of the one or more base content items. Also, the citation may include or identify the style, genre, geographic designation (e.g., French Impressionism), era of the base content item(s), as well as an identifier of a cluster of content items in the database where the one or more base content items are found. For example, content in the database may first be organized by clustering items by style, genre, era, artist/creator, source, or the like. In addition, copyright information, including copyright license terms of use, geographical and other restrictions, and copyright expiration dates may also be included.

The content citation may also indicate a similarity score or a degree to which the output content overlaps with, or is similar to, the base content item(s). For example, the content citation may indicate that the output content is 25% similar to a base content item X. The content citation may also indicate the portion of the output content that overlaps or is similar to the base item(s). For example, the content citation may indicate that the similarity occurs in a particular area in a visual output content, such as in a rectangle of width 1,200 pixels and height 2,400 pixels starting at x, y coordinates 790, 890. A segmentation mask defining a regular or irregular shape may be used to indicate the portion of output content that overlaps or is similar to base content item(s). In other examples, the content citation may indicate that the similarity occurs starting at 88.2 seconds and ending at 102.0 seconds in audio/music output content, or may indicate that the similarity occurs at frames 608-1040 in video output content.

According to another aspect of the disclosure, a remediation system or process, which in an implementation may be part of a generative-AI server or system, may determine excessive (e.g., above a threshold) similarity between the output content produced by the ML model and one or more base content items that the system predicts or determines that the ML used or may have used as base content items. The remediation system, which may be part of the citator or a separate system in communication therewith, may then cause alteration of the output content by altering one or more portions of the output content to make the output content less similar to, or otherwise more distinguishable or distinct from, the base content items. For example, the system may determine excessive similarity of a portion of an output image generated by the ML model with a content item that the system estimates was used by the ML model as the base content item. In an example, the remediation system uses inpainting techniques to remove and/or otherwise alter the similar portion(s) of the output content. In an implementation, the similarity to the base content item could be left in, or the similarity of the portion, or of the output content as a whole, may be increased as desired, such as if permission is received from the content source.

The system may cause alteration of the output image by creating a new or altered text prompt that is input to the ML model so the ML model generates a new output image. The original text prompt may be modified, for example, by adding a negative prompt-a Boolean operator that excludes a term or other element. For example, the exclusion may specify a title of a work, an author, period, a source or the like. In some embodiments, the system may generate a new text prompt based on metadata that is associated with the base content item. For example, a style, author, period, title of a work, source or the like specified in the metadata may be processed to identify an alternative style, author, period, title of a work, source or the like to be used in the new text prompt. The new text prompt may then be fed to the ML model as a supplement to the original text prompt, or in place of one or more terms of the original text prompt. For example, an additional term may be a term that specifies more or less of a style (e.g., in the pointillist technique/style or in the style of Picasso/cubism), a term that specifies features (e.g., with primarily pastel colors), and/or content components (e.g., more or fewer sunflowers, particular text or other audio/video components). In an embodiment, the system may cue (e.g., suggest to and/or propose to) a user to alter the text prompt or to select a new text prompt.

In an embodiment, the remediation system may be an adjunct of the generative AI system or configured as part of the same system, such as a server system that returns ML model-generated output content and remediation thereof. In an embodiment, the citator used to filter the database for finding base content items to generate a citation may also be configured as part of the same system as the generative AI system, for example, provided as part of the same server over a network.

In an implementation, the citator that finds base content items and generates the citations may receive limited information from the generative AI system. For example, the citator may receive a text prompt embedding that is generated by the ML model, output content embedding(s) generated by the ML model, and style and/or component features (e.g., represented by a bag of visual words) obtained based on the output content. For example, component features may be generated using feature detection algorithms, such as SIFT (Scale-Invariant Feature Transform). The citator may use SIFT features and RANSAC (Random Sample Consensus) to identify specific components that correspond between the output content and a content item, and further identify locations of such identified components. The citator may use the same database(s) as those used to train an ML model that generates the output content, or may use one or more different databases. The database(s) used by the ML model to generate the output content may be the same one(s) used originally to train the ML model. The database or content used by the ML model to generate the output content may be different from the database or content used to originally train the ML model, for instance, when a user provides separate reference content to help guide the output generation. The citator may use one or more trained ML models configured to filter the database to find base content items and to generate citations, to determine similarity between the output content and an identified base content item, and to cause or provide instructions to the generative AI system for generation of alternative output content.

A method, system, apparatus, non-transitory computer-readable medium, and means for implementing the method are disclosed for using a citator or citation system to determine a citation for output content generated by a generative AI system. An illustrative method may include, for instance: determining a first set of one or more content items by filtering content items in a content database based on a text prompt embedding, wherein the text prompt embedding is generated based on a text prompt used by the ML model to generate the output content; determining a second set of one or more content items by filtering the first set of content items using an output content embedding, wherein the output content embedding is generated based on the output content generated by the ML model; identifying a base content item for the output content by filtering the second set of content items using a component feature, wherein the component feature is generated based on the output content; and transmitting the citation for the output content based on the identified base content item.

The output content may include an image, audio content, and/or video content generated by the ML model.

Various types of pre-processing of the content database may be performed, including clustering content items of the content database by style. The second set of content items may be determined by filtering the first set of content items based on the clustered content items (for example, the content items in the database may be clustered by style or genre) and using a style embedding generated based on the output content. The style embedding may be generated by another trained ML model (e.g., not the ML model used to generate the output content) from analyzing the output content to encode stylistic elements of the output content.

After the filtering of the second set of content items using the component features (e.g., using a bag of visual words), a similarity score may be obtained for a base content item of the citation. The similarity score may indicate a degree of similarity (e.g., 75% similarity) between the base content item indicated by the citation and the output content, and/or the similarity score may indicate a degree of similarity (e.g., 85% similarity) between a portion or feature of the output content (e.g., an area of similarity indicated by a bounding box) and a portion of the base content item or the entire base content item. The similarity score may be determined using a scale-invariant feature transform (SIFT) process. The process may further entail obtaining matched SIFT keypoints or locations in the output content to generate a segmentation mask that identifies or corresponds to locations of matched features. For example, based on the obtained matched SIFT locations, the citation may indicate a first portion of the output content of greater similarity to the base content item than a remaining portion of the output content item.

The citation may include one or more components, for example: attribution information indicating a title or source of the base content item; a similarity score indicating a degree of similarity between the output content and the base content item; copyright restriction information for the base content item; a human-perceptible watermark provided on the output content indicating the base content or indicating ownership of the base content; and/or a machine-detectable watermark imperceptible to humans and provided on the output content indicating the base content or indicating a source of the base content.

A method, system, apparatus, non-transitory computer-readable medium, and means for implementing the method are disclosed for determining a citation for output content generated by a trained generative machine learning model and remediating similarity (e.g., similarity that exceeds a threshold similarity score) to cited base content item(s). Such a method may include, for example: transmitting, to a citation server, a text prompt embedding, wherein the text prompt embedding is based on a text prompt used to generate the output content; transmitting, to the citation server, an output content embedding, wherein the output content embedding is based on the output content; transmitting, to the citation server, a component feature, wherein the component feature is based on the output content; and receiving, from the citation server, a citation to an identified base content item, wherein the identification of the base content item is based at least in part on filtering of content items in a content database using the text prompt embedding, the output content embedding, and the component feature.

The content database may be the same one used to train the ML model generating the output content, or may be one of several such databases.

The similarity may be determined as overall similarity of the output content to the base content item, or to a portion of the base content item. Or, similarity may be determined as an area of similarity in the output content with the base content item, or a portion of the base content item, or a style similarity. For example, generating of the alternative output content may be focused on, or may include, altering the area of similarity in the output content.

The output content generated by the ML model (the first output content) may be generated based on a first text prompt received by the ML model. Generating of the alternative output content may include: generating a second text prompt different from the first text prompt; and receiving from the ML model a second output content different from the first output content. The generating of the alternative output content may entail using an additional ML model for editing purpose, which will take the previous output image, a visual citation, and a second text prompt which instructs the ML model to modify the previous output image and generate a new one that helps to negate the visual citation. This second output content may be generated by the ML model based on the second text prompt. For example, the second output content may be a re-working of the first output content to reduce similarity of the area of similarity of the output content or of the output content as a whole.

Generating of such a second text prompt may be desired when a high degree of similarity is determined, when a copyright or other restriction is identified with respect to a base content item, and/or when an area of similarity in the output content cannot be removed or altered because such removal or alteration would impact or remove one or more important portions of the output content or one or more central or large portions of the output content. In such cases and others, the second text prompt may be generated in response to determining that the similarity corresponds to a similarity score that meets a second threshold similarity criterion greater than the first threshold similarity criterion. Generating of the second text prompt may entail an alteration of the first text prompt. For example, a term of exclusion may be added to the first prompt. Metadata associated with the base content item may be retrieved and used, directly or after further processing, to generate the second text prompt. For example, the system may select a general style or period rather than a particular artist or artwork corresponding to the base content item indicated by the metadata.

The system may add a watermark on the output content identifying the base content item. The watermark may be a human-perceptible watermark provided on the output content indicating the base content or indicating ownership of the base content, as well as other such information based on the citation. The citation information may be retrieved from metadata associated with the base content item or obtained in other ways, for example, metadata accessible via the internet. In addition, or instead, a machine-detectable watermark visual imperceptible to humans may be inserted to the output content indicating the base content or indicating a source of the base content, or one or more of the foregoing components.

The system may determine a copyright restriction based on copyright information identified for the base content item, for example, from the metadata corresponding to the base content item. Generating of the alternative output content may be performed in response to the determining of a copyright or other restriction. For example, based on the determined restriction, the system may determine that the copyright owner has not granted permission for particular uses of the base content item.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following Figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates an example of a process of a user entering a prompt to a generative ML model and displaying artwork generated by the ML model together with a citation to base content that is similar to the generated artwork, according to an aspect of the disclosure;

FIG. 2 illustrates an example of another process of the user entering a prompt to a generative ML model and displaying artwork generated by the ML model together with a citation to base content, and also showing remediation steps that may be taken in response, according to another aspect of the disclosure;

FIGS. 3A-3C are communication and processing diagrams illustrating an example of operations performed to provide output content and citation of base content, according to an aspect of the disclosure;

FIGS. 4A-4B illustrate an example of visual citation metadata structure, including style citation and element citation, respectively, according to an aspect of the disclosure;

FIG. 5A illustrates an example of output content provided as visual art and also includes a bounding box that indicates an area of similarity to a cited base content item, according to an aspect of the disclosure;

FIG. 5B illustrates an example of a cited base content item and includes a bounding box that indicates an area of similarity to a corresponding portion of an area of similarity in the output content, according to an aspect of the disclosure;

FIG. 6 illustrates an example of a computer system for implementing methods described herein, according to an aspect of the disclosure;

FIG. 7 illustrates a system including a server connected to a database in communication with other nodes via a network, according to an aspect of the disclosure;

FIG. 8 illustrates an example of a process for base content generation and additional operations, according to an aspect of the disclosure;

FIG. 9 illustrates an example of remediation operations based in part on identifying similarity between output content and a base content item, according to an aspect of the disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

References herein to an “ML model” may include various types of text-to-image or other types of generative AI technologies, for example, generative pre-trained transformer (GPT) models. Other ML models and other techniques may also be utilized in implementing techniques disclosed herein, such as to determine characteristics or embeddings of input text prompts, output content items, and reference or base content items, and to efficiently find, analyze, and quantify similarities between an output content item and a base content item. For instance, natural language processing (NLP) techniques can be used to process user prompts, and CLIP (Contrastive Language-Image Pre-training) can be used to generate an embedding from text (e.g., from a text prompt provided to a generative AI system for generating output content). CLIP maps textual descriptions to corresponding images. Generally, an embedding is a representation of an object (e.g., text or an image) using a real-valued vector that encodes the meaning of the object in such a way that the objects that are closer in the vector space are expected to be similar in meaning.

Illustratively, ML models may obtain word embeddings using language modeling and feature learning techniques in which words or phrases are mapped to vectors of real numbers. An ML model may also use word embeddings, numerical representations of words in a text prompt, to map each word (such as of a text prompt) to a high-dimensional vector, where similar words are represented by vectors that are closer together in the vector space. Word embedding techniques include, e.g., Word2Vec, GloVe (Global Vectors for Word Representation), and FastText.

Style embeddings encode stylistic elements of content items, such as, for example, texture, brushwork, and color schemes. Moving beyond style, vector-based embeddings that convert images into high-dimensional vectors, may allow nuanced searches to be performed that go beyond simple pattern recognition, and allow for sophisticated queries based on stylistic and compositional content. Vectorization processes may allow for the quick retrieval of relevant images from extensive databases to establish visual citations, as discussed herein.

The “bag of visual words” model translates the principles of text analysis into the visual domain. This method breaks down images into feature descriptors that can be matched with a pre-defined visual vocabulary, which may enhance efficiency and accuracy of image search and comparison. This may be used for identifying and cataloging elements for visual citations.

Feature detection and matching techniques or algorithms, such as SIFT and RANSAC, may be used to identify consistent features across varying conditions for images and robustly matching these features. These techniques may be employed to determine the influence or derivation of elements within AI-generated images.

Non-Maximum Suppression (NMS) may be used to help identify visual citations. NMS plays a role in discerning distinct, non-overlapping elements. By applying NMS, the disclosed techniques may resolve instances where multiple similar features are detected, which may help to ensure that each visual citation is unique and accurately localized within generated output content.

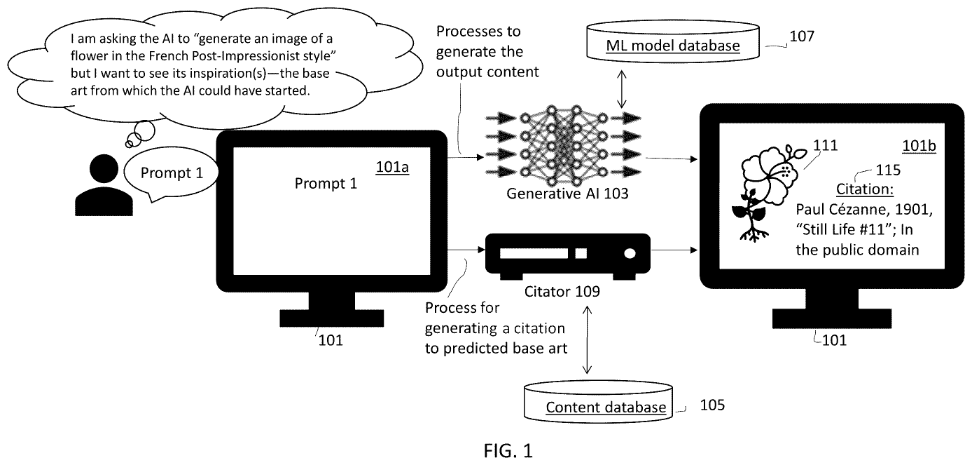

FIG. 1 illustrates an example of citation generation, according to an aspect of the disclosure. A user may enter a prompt to a generative AI system to request generation of an image, or to request creation of some other visual and/or audible and/or video and/or multimedia output content. The user may also be interested in receiving an analysis of the base content, such as the visual art, that the AI may have used, or could have used, as inspiration or basis for generating the output content. A citator 109 may be a system, such as a server, that may perform tasks entailed in identifying the one or more such base content item(s) and may generate a citation that identifies the base content item(s). In an embodiment, the citator 109 may also recommend, direct, or automatically initiate remediation steps to address excessive similarity between the output content generated by the AI and the base content item(s). The base content item(s) that a citator 109 provides in the citation an indication of one or more items that the ML model may have used in generating the output content, or, according to an aspect of the disclosure, finds a threshold level of similarity between the base content item(s) and the output content. For example, a user may check a box or otherwise make a selection for requesting a citation and/or make a selection for requesting to see similar base item(s) and/or make a selection for requesting checking for potential copyright issues. In an implementation, providing a citation may be a default option when requesting output content from the generative AI system.

A computer or computing device 101 may have a user graphical user interface 101a that displays the text prompt that is provided to the generative machine learning model for generating the output content 111 shown by graphical user interface 101b. The generative machine learning model that generates the output content may be part of generative AI system 103. The ML model of the generative AI system 103 may access machine learning model database 107 for generating output content 111 shown in the graphical user in the face 101b of the computer 101.

As the ML model of the generative AI system 103 generates the output content, a citator 109 performs a process for generating a citation for the output content and predicting the base content that was used, or could have been used, as inspiration by the ML model in generating the output content 111. As shown in FIG. 1, the graphical user interface 101b may display or otherwise provide a citation 115 that is generated by the citator 109. The citation 115 may include the name of the artist, the year of its creation, its title, and may describe whether it is in the public domain or protected by copyright, for example. In an implementation, the citation may identify how many times this base content item has been used by generative AI system to generate output content items and what portion or portions or features or other aspects of this base content item have been used by the generative AI system to generate output content items. For example, the citator 109 may maintain metadata (e.g., as part of content database 105) indicating the number of times this base content item has, or portions or features or other aspects of this base content item have, been cited for output content items generated by the generative AI system.

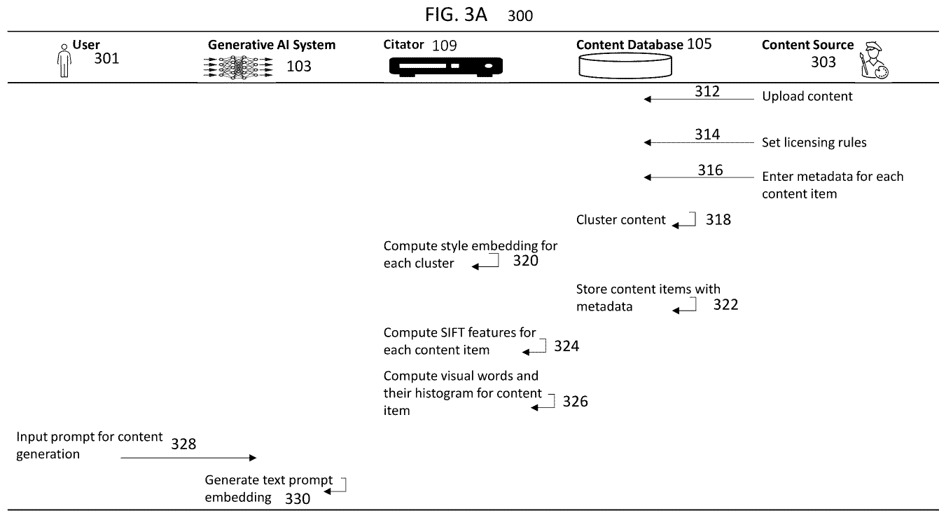

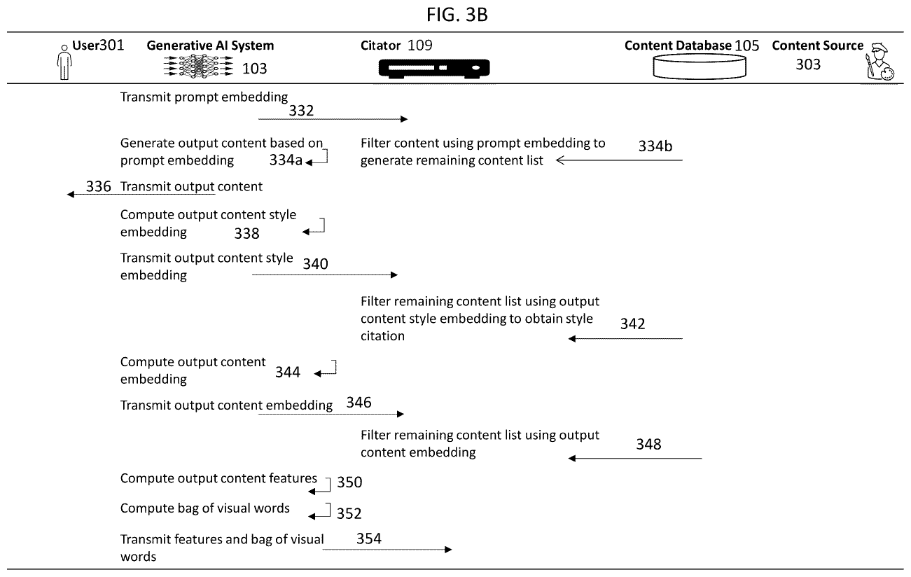

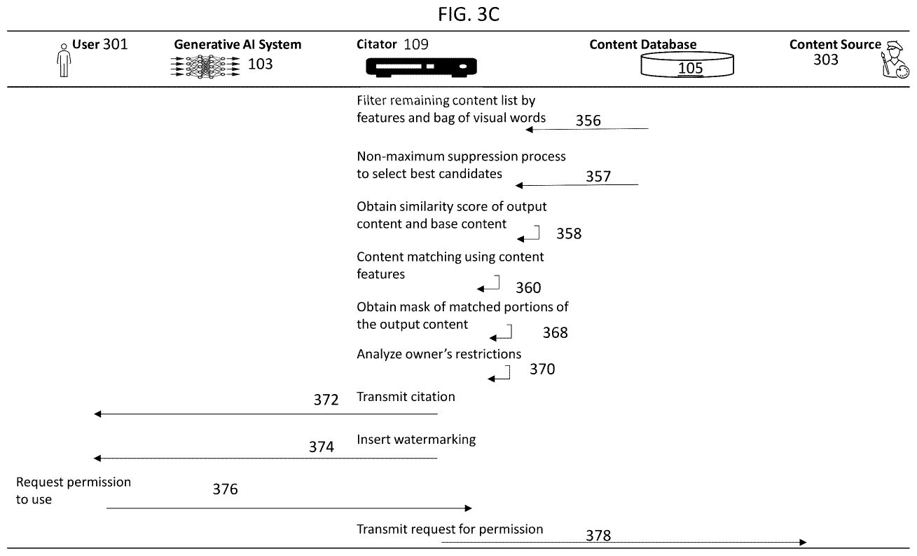

The citation may identify usage restrictions for the base content item. The citation may reproduce the base content item(s) for reference, for example, a thumbnail of a painting. In addition, or instead, the citation 115 may include other information, such as information based on metadata associated with the base content item (discussed below with regard to FIG. 3A). It will be understood that the citation may include more than one work or content item, such as when portions of such base content items are considered similar to or bases of portions of the output content. While described with reference to a visual art example, it will be understood that the citation generating process may provide citations to audio works, such as songs, or other musical pieces, video content, such as films, combination of such works, such as multimedia content, and the like.

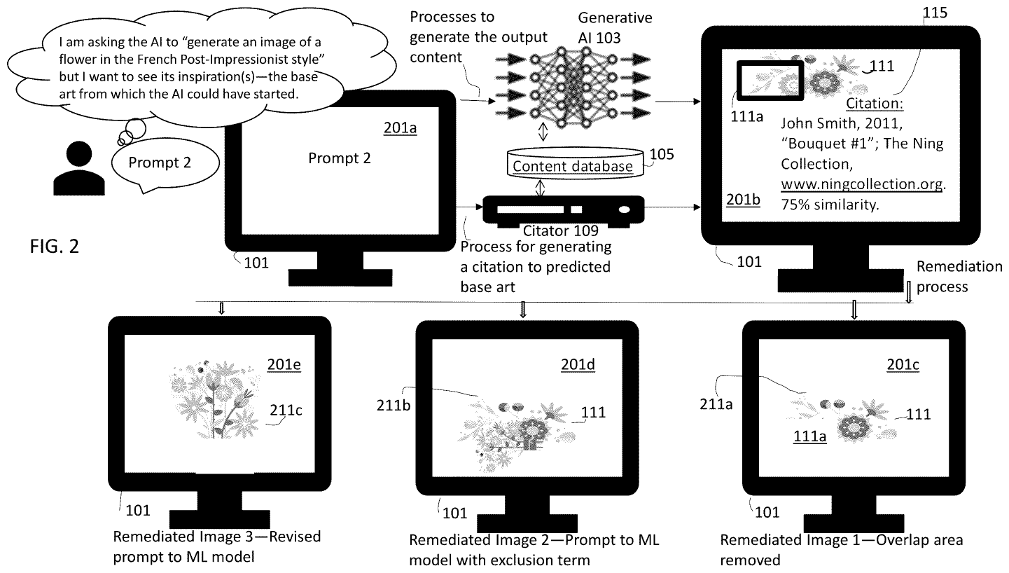

FIG. 2 illustrates a citation server or system that is configured to remediate similarity of output content to predicted base content. A user may provide a prompt, as shown by graphical user interface 201a of computer or computing device 101, to the ML model for generating output content 111 The ML model may use the same content database 105 as used in the citation process, or may use a different content database (e.g., database 107) to generate output content.

As shown by graphical user interface 201b of computer 101, the output content 111 may contain an area of similarity 111a that is identified by the citator 109 as being similar in excess of a similarity threshold to the base content that the citator 109 identifies in the citation 115. Citation 115 may also indicate a degree of similarity, shown in this example as 75%, of the output content 111 to the base art identified by citation 115. In addition, the citation 115 may also identify the degree of similarity of the area of similarity 111a of the output content 111 to the base content identified by the citation 115. In an embodiment, the system may take or suggest remediation if the degree of similarity in the area of similarity 111a exceeds or meets a threshold, for example, 75%, or 85%, even if similarity as a whole between the base content and the output content is below a threshold. In an embodiment, the system suggests or initiates remediation based on overall similarity, even if no particular area of similarity is determined.

As also shown in FIG. 2, various remediation steps may be undertaken by the system automatically, for example, in response to detection of an overall similarity score that exceeds a threshold similarity, or in response to detection of a similarity score that exceeds a similarity score of the area of similarity 111a. In an embodiment, the system may provide a notification or warning in the citation, or in addition to the citation, of excessive similarity, and the remediation may be performed in response to user input requesting remediation. In an embodiment, the system may initiate remediation automatically in case threshold similarity is met or exceeded, for example, without or prior to providing the output content to the user.

As shown by graphical user interface 201c, the system may remediate excessive overlap by removing or otherwise modifying the area of similarity 111a from the output content 111. For example, if the degree of similarity in any area or portion of the output content exceeds or meets a threshold, for example, 75%, or 85%, this area or portion may be determined as the area of similarity 111a. Inpainting or other techniques may be used to alter the area of similarity, for example, by toning down the degree of similarity, moving and/or reorienting and/or resizing the area of similarity, and/or changing one or more colors or lines of the area of similarity. More than one such area of similarity 111a may be identified and remediated. A remediated output content 211a is displayed by graphical user interface 201c.

As displayed by graphical user interface 201d, the system may remediate excessive similarity by prompting the ML model to create a regenerated output content 211b by adding an exclusion term to the text prompt. The exclusion term may include, or be based at least in part on, the base content item and/or particular style, component, or feature of the base content item identified by the citation. The exclusion term may be a term or phrase specifying that the ML model avoid and/or minimize use of works by a particular artist or source, or avoid and/or minimize use of a particular piece of art, or not generate a flower with concentric yellow rings, or not generate a flower with yellow rings in the area of similarity 111a, or the like. The regenerated text prompt may be automatically generated by the system in response to detecting the excessive similarity score, or may be automatically generated by the system in response to receiving a user request to remediate the similarity. For example, the system may determine, using machine vision, a flower with concentric yellow rings as being a central element in the area of similarity 111a identified by the citation process 109. In response to such a determination, the system may generate a revised text prompt with an exclusion term directed to such a flower. Or, based on the identification of the artist (or of the style, genre, source, etc.) of the base art identified by the citation 115, the system may generate a revised text prompt with an exclusion term directed to this artist (or to this style, genre, source, etc.).

According to a further aspect, the system may revise the text prompt more generally and/or suggest that the user revise the text prompt. As shown in graphical user interface 201e, a regenerated output content 211c may be obtained from the ML model based on a substantially reworked text prompt that is then input to the ML model. In an embodiment, the reworked text prompt may be automatically generated by the system, for example, by changing the style, genre, period, database used for content, etc. Remediation may also comprise a combination of such measures, for example, the system may remove the area of similarity and also request regenerated output content with an exclusion term in the input prompt. In an embodiment, the remediation may comprise removing the area of similarity and also inserting a watermark onto the output content. The watermark may cite the base content and may contain other aspects of the citation discussed herein. In an implementation, the watermark may be imperceptible to humans with the naked eye.

In an embodiment, the watermark may be inserted and may be embedded in the output content that is provided to the user. For example, the citation, or a portion thereof, may be embodied in, or may include, a watermark that is provided in the output content. The watermark may identify a copyright owner or copyright creator and a year of the creation of the copyright of the base content. The watermark may be perceptible to a human eye. In an embodiment, the watermark may be invisible to a human eye, but detectable by a machine reader. For visible watermarks, a non-intrusive text overlay or a QR code may be placed in the image, linking to a page that lists all the visual citations and possibly additional information about the original base artworks or and their creators. The choice of what is displayed in the citation may be based on the agreement with the artist, for example, specified in the licensing terms. In an embodiment, base content item may be cited or inserted as a watermark only if the output content has at least a threshold similarity, for example, 70% or 80%, to the base content item.

The generative AI system 103 may be trained using one or more content databases, which may be local or remote from the machine that runs the ML model. The machine learning model may be trained using supervised or unsupervised methods. Pre-processing of data may comprise several operations and may be performed on database 105 by a database management application prior to receiving user prompts described herein. While sometimes referred to as database 105, it will be understood that database 105 may be understood as two or more databases located remote from each other.

FIG. 3A is a communication and process flow diagram showing an interaction process 300 between various actors in the citation generation process. Content creators, content owners, content mediators or other content sources 303 may upload content items to a content database 105. Metadata for each content item may indicate copyright information, such as the name of the author (content creator), the year the content item (or the work that the content item replicates or on which the content item is based) was first created, the year the content item (or the work that the content item replicates or on which the content item is based) was first published, whether copyright has been registered for the content item (or for the work that the content item replicates or on which the content item is based), whether the author has dedicated copyright to the public, any assignees of the copyright in the content item (or in the work that the content item replicates or on which the content item is based), location of an original work on which the content item in the database is based, and/or other such information. The content items in the database 105 may be preprocessed, for example, clustered by style, genre, period, author, geographic region of origin, or the like. Also, a style embedding and/or a content/feature embedding may be calculated for each content item in the database as part of the preprocessing. In an implementation, the embeddings may be stored as metadata for each content item in the database. Such metadata and such embeddings may be used later for matching the output content with base content item, as described below.

A user 301 may enter a text prompt to a generative AI system, in response to which the generative AI system returns output content. The user 301 may request, at the time the user 301 enters the text prompt or at a later time, a citation for the output content that indicates one or more base content items. A multistate filtering process may be performed, for example, by citator 109 to identify the base content item. Metadata associated with the content items in the database, and style embeddings and content/feature embeddings associated with the content items in the database, may also be used to identify the base content item. In addition, or instead, a list of content features, such as a bag of visual words, may be used to identify the base content item. The generative AI system may return output content responsive to the user's text prompt. The citator 109 may generate a citation identifying the base content item. The output content and its citation may be generated in real time.

At 312, content source 303, such as an artist, author (or representative or estate of artist or author) studio, or the like, uploads or otherwise provides content to a content database 105. Content database 105 may be a private or proprietary database, or may be a public database accessible to entities other than citator 109.

At 314, content source 303 may set licensing rules for the items of the content database 105. The licensing rules may specify conditions under which the uploaded content may be used by others, for example, pursuant to applicable copyright laws. The licensing information may include restrictions on the various forms of usage and reproduction of the content, such as printed publication, or sound recordings, distribution of copies of the content item, public performance, display, or playback of the content item, broadcasting, or other communication of the content item; adaptation, including transformation of the output content to other media, for example, creating a series of photographs of a painting, or creating sculptural works based on the art, or translation of the content item into one or more languages; and/or geographic restrictions, such as in which countries or regions the content item may be used, or may not be used in prescribed ways. The licensing rules may specify such restrictions in a negative manner, for example, geographic areas in which the contact item may not be displayed, or may be stated in an affirmative way, such as one or more jurisdictions or regions in the content item may be used.

Other licensing information may be provided, for example, information identifying the owner or current source for obtaining rights to content, the publisher of the content, the year of the creation of the copyright, whether the copyright has been registered with a government authority, the jurisdictions in which such registration has occurred, the dates of registration, whether any litigation or enforcement of the copyrights in the content exists or has existed, and the like, whether the copyright is still in force, and the expiration of such rights,

At 316, metadata associated with content items stored may be uploaded to content database 105. Metadata may contain various pieces of information, including, style, genre, title, episode titles, a type of media asset, an original air date, a season number, an episode number, a program episode number, author, composer, director, producer, date of composition, copyright date and other copyright information, including copyright license terms, contact information for copyright owner or owner's representative, studio, recording label, a source where the content (or the work that the content item replicates or on which the content item is based) is available, URL of current database record, a tracking number or bar code, style, genre, era, size, author notes, the existence of copyright in the content or the work that the content item replicates or on which the content item is based Such data may be included for the media asset in two or more languages. In an embodiment, one or more pieces of such metadata or the licensing rules may be obtained in other ways and uploaded or otherwise provided to the content database 105, for example, automated processes may be used to generate such metadata for the content database 105. A word embedding machine learning model may also be employed to determine one or more pieces of information for such metadata, for example, to generate a style or genre of the content. The database management application may perform pre-processing on such database records.

At 318, the content database 105 may be sorted or clustered by style, genre or period or the like. These clusters may be grouped by specific artists or artistic movements, creating sets such as Monet-Impressionist or Author A-Expressionist, which facilitates more nuanced and efficient searching and matching. Additional clustering may also be provided within each cluster, for example, each style cluster, for example, post-impressionist painting, may be sorted by artist, or a more general cluster, such as 20^{th} century art may include more than one subcluster, for example, sorted by style of art. In addition, any given content item may be included or indexed in more than one cluster because of the overlap. For example, the database may include content clustered by style and content clustered by era, for example. It will be understood that additional pre-processing operations may be performed on the content as necessary for ML model processing.

At 320, citator 109 may compute a style embedding for each cluster. This process may encode stylistic elements based on texture, brushwork, and color schemes, for example. At 322, style and/or style embeddings may be stored or included as part of the metadata associated with corresponding content items. At 324, component features, for example, scale-invariant feature transform (SIFT) features may be computed for each content item in the content database 105. The style embeddings, component features, for examples SIFT features may be stored (e.g., as metadata associated with the content items in the content database 105). For non-visual art, other analogous embeddings and features may be computed. At 326, citator 109 may compute bags of visual words, and visual word histogram(s) for each content item, and these bags of visual words and histograms may be also stored in the database, for example, as metadata associated with their respective content items. These steps may facilitate later matching of the output content with similar content items in the database.

At 328, the user may input a text prompt for content generation. While referred to as a text prompt, the user may speak the prompt into a microphone and the computer 101 may have access to a speech-to-text system that generates a text transcription of the user's utterance. At 330, the generative AI system 103 may generate a text prompt embedding based on the text prompt received from user 301. The generative AI system 103 may include or otherwise use the ML model that generates the output content. In addition, the generative AI system 103 may include one or more other modules, including trained ML models, for generating various inputs to the citator 109. For example, at 330 the text prompt embedding may be generated using CLIP, e.g., by a trained ML model of generative AI system 103, based on the text prompt. The ML model that creates the output content may use the same text prompt to create the prompt embedding that is passed to citator 109, or the prompt embedding may be generated separately by citator 109. At 332, the prompt embedding is transmitted to (or generated by) the citator 109.

At 334a, the ML model may generate the output content 111, at this stage or later, based on the prompt, which may then be displayed to user at 336. In an embodiment, the output content 111 is provided to the user together with the citation. Thus, as shown in FIG. 1A, the computer may display the output content 111 together with the citation 115 at the same time. In an embodiment, the citator 109 may transmit a notification to the content source 303 (e.g., copyright owner, copyright clearinghouse, artist/base content item creator, and/or a representative of one or more of these) of the base content item in addition to, or instead of, to user 301, indicating that a similar output content has been generated. For example, such notification may show the output content, and may indicate other aspects of the information provided in the citation, for example, the similarity score. The notification may show an area of similarity with the base content item.

At 334b, the citator 109 may filter content in content database 105 using the prompt embedding. For example, the citator 109 may use the prompt embedding to generate a first set of content items with potentially relevant base content items by finding content items in the content database 105 whose metadata corresponds to the prompt embedding. The output content generation process and the filtering process shown at 334a, 334b may be, but need not be, performed in parallel. In addition, other operations referenced in FIGS. 3A-3C may be performed in parallel. At 336, the output content may be transmitted to the user 301. In an implementation, the output content may be transmitted to the user 301 at a later time, for example, together with the citation at (or after) one or more of processes 372-378.

At 338, the generative AI system 103 may compute an output content style embedding based on the output content 111 that has been generated at 334a. At 340, the style embedding generated based on the output content 111 is transmitted to the citator 109.

At 342, the citator may find the best or relevant content matches in the database based on a correspondence of the style embedding generated based on the output content with the embeddings of each style cluster in the database, As discussed, a style embedding may have been computed and stored in the pre-processing stage for each content item in the database 105. These embeddings may at this stage be compared with the style embedding of the output content. In this way, the best or corresponding style matches based on the style embedding may be used to generate a second set of content items, based on further filtering of the first content item list. The second content item list may be formed by eliminating or filtering-out base content items from the first set of content items based on the style embedding received at 340.

Citator 109 may be a network server that independently finds base content items in one or more databases, and generates citations for the output content without input from the generative AI model 103. In this approach, the computer 101 that receives the text prompt from the user may separately transmit the text prompt to the generative AI system 103 and to the citator 109, with or without informing the generative AI system 103 that a citation is being requested. The citator 109 may then independently generate the text prompt embedding using its own ML model. Then, when the computer 101 receives the output content from the generative AI system 103, the computer 101 may forward this output content to the citator 109, which may then independently generate the output content embedding, and style and component features using its own ML models. In this way, the citator 109 may independently provide citations, similarity scores, and areas of similarity with or without alerting the generative AI system 103. The output content style embedding, at 340, may be transmitted to citator 109.

At 344, the generative AI system 103 may compute, using vector-based image search technology, a content embedding (sometimes referred to as a feature embedding or component embedding) based on the output content 111 that has been generated at 334a. For example, in the case of visual art content, the content embedding may be an image embedding generated based on the output content. At 346, this embedding may be transmitted to citator 109.

At 348, the content embedding received at the 346 may be used by citator 109 to filter the second set of content items. As discussed, a content/feature/component embedding may have been computed and stored in the pre-processing stage for content items in the database 105. Embeddings of the content items in the database, whether computed at a pre-processing stage or afterward, may at this stage be compared (e.g., using vector-based image search techniques) with the content embedding of the output content. In an embodiment, the style and content embeddings may be computed in one set of steps, the style and content embeddings of the output content may be transmitted together to the content database 105, and the filtering of the set of content items based on style and content embeddings may be performed in another set of steps to generate the second set of content items.

At 350, the generative AI system 103 may compute local content features (sometime referred to as component features or as visual features) of the output content. In an embodiment, machine vision techniques may be used to generate content features. For example, in the case of visual artwork, the database may find scale-invariant feature transform (SIFT) features or keypoints as the content features. At 352, the generative AI system 103 may compute component features (e.g., a bag of visual words). This may be performed while the content in the database is being filtered using style embeddings and content/feature embeddings to generate the smaller list of candidate base content items.

At 354, the content features and the component features may be transmitted to citator 109. In the case of non-visual art, instead of a bag of visual words, other such items or features may be provided to citator 109.

At 356, shown in FIG. 3C, citator 109 may filter the remaining items on the second list using content features (e.g., SIFT features) and the component features. SIFT-RANSAC (Random Sample Consensus) may be used to conduct refined image matching: to identify specific locations and masks where features match. Bounding boxes may be used to track portions similar to the output content. SIFT detects distinctive local features or keypoints like corners, blobs, and edges that are invariant to scaling, rotation, and other transformations. RANSAC is used in conjunction with SIFT to estimate the geometric transformation between the matching keypoints, filtering out outlier matches. Matching keypoint locations may be enclosed by bounding boxes, indicating corresponding regions of high visual similarity between the AI-generated output content and database images. This mapping enables localization of specific visual elements borrowed or derived from the database images within the new AI-generated composition. The bounding boxes can then be used to assess which candidate base content items are going to be cited as the base content item(s), and may also be used for accurate visual attribution of specific portions of content “borrowed” (or at least similar to) the output content.

At 357, a non-maximum suppression (NMS) process or method may be used to resolve instances where multiple similar candidate base content items are detected, and thus to cite the most similar base content items among the candidate base content items and to identify the area of greatest similarity. In an example implementation, after the SIFT-RANSAC processing is performed to obtain the bounding boxes on areas of similarity on candidate base content items, the NMS process may be used to sort the bounding boxes, initialize best matches, and iterate through the sorted boxes. In this example, the NMS process may sort the bounding boxes detected across the candidate base content items of the database in descending order based on a confidence score (e.g., a number of inlier SIFT matches, transformation residual error). The NMS process may initialize best matches by creating an empty list to store the final set of best non-overlapping matches. In this example, the NMS process may iterate through the sorted boxes by taking the highest confidence bounding box that is not already processed, adding this bounding box to the best matches list, and comparing this box with the remaining unprocessed boxes: If the Intersection over Union (IoU) with another box exceeds a threshold (e.g., 0.5), the NMS process may discard the lower confidence box as it significantly overlaps. IoU (sometimes known as the Jaccard similarity coefficient) may be used to gauge similarity and diversity of sample sets. If the IoU with another box does not exceed the threshold, the other box may be kept for further consideration. The iteration through the sorted boxes may be repeated until all boxes are processed.

The NMS procedure may tend to obtain the best matches list with a higher confidence by eliminating bounding boxes that have minimal overlap with each other. In this way, redundant matches from the same source region may be avoided, and citations may be more accurate. The IoU threshold may be tuned based on how conservative the system should be in allowing overlap between matches. A higher threshold will result in fewer final matches but greater separation between them. Additionally, NMS can be applied hierarchically by first obtaining non-overlapping matched regions, and then detecting non-overlapping keypoint matches within each region for precise visual attribution.

At 358, citator 109 may obtain a similarity score of output content and a base content item, for example, based on the component features. A similarity score may be generated using any suitable methods of comparing images or other types of content items. In this way, a base content item for the citation may be identified.

In an implementation, the area(s) of the above-identified bounding box(es) of the base content item may be used to generate a similarity score. In an embodiment, algorithmic/statistical methods may be employed, for example, a trained ML model may use a correlation score between the two images based on normalized values in two matrices to compare based on style and component (content) features.

At 360, specific areas or portions of the output content may be matched. As discussed, these areas of similarity may have been identified, for example, using SIFT-RANSAC methods discussed above.

The process may generate one or more matched feature locations or portions in the output content. In an embodiment, a similarity score of the area of similarity of the output content with the base content, or with a portion of the base content, may be computed based on such features. In an embodiment, such a similarity score for the area of similarity may be a separate similarity score from the overall similarity score based on the similarity of the output content as a whole to the base content item, or to a portion of the base content item. At 366, the citator 109 may generate a mask of matched portions of the output content and the base content that has been identified. For example, the mask may be a bounding box, as shown in 111a of FIG. 2, that identifies the location of substantial overlap, or overlap that exceeds a similarity threshold, for example, 90%, between the output content and the base content identified. The mask or bounding box may be of any regular or irregular shape.

At 368, citator 109 may mark a mask of matched portions in/on the output content. A bounding box may be generated to indicate increased similarity.

At 370, terms of the copyright license or the provisions under which the owner permits use of the base content may be analyzed by the citator 109. The citator may refer to the relevant jurisdiction's copyright laws to determine whether a content item has passed into the public domain. For example, the citator may determine that the base content is in the public domain because the date of its creation is more than 70 years after the death of the artist who created it. At 372, the citation is transmitted by citator 109 to the user/user's device. In embodiment, if the style matches or exceeded a predefined similarity style threshold, then these style citation may not be sent to the user-instead, the citator 109 may notify the user that the output content is excessively similar to base content item. In an embodiment, a watermark may also be added to the output content at 374.

At 376, user may be enabled to request permission to use the output content from the copyright owner or owner's estate, agent or representative. The request may be transmitted to citator 109, to the content database 105 and/or to the content source. The request may include the output content and the base content for which permission is requested. The request may show the area of similarity 111a, and/or the degree of similarity and/or the watermark and/or the intended use of the output content. At 378, the request may be forwarded to the copyright owner or to another source of the base content.

In an embodiment, to maintain privacy and to respect copyright in the content stored in the database 105, the system ensures that the ML model that creates the output content and other third party systems have no direct access to the content database 105 except via the citator 109. In an embodiment, citator 109 may have no excess to the database 105 but may pass parameters as discussed herein to the database 105 for filtering content items therein so that ultimately, if a predefined similarity threshold is met or surpassed, a matching base content item is returned by the content database to the citator 109 or a citation to the base content is returned to the citator 109.

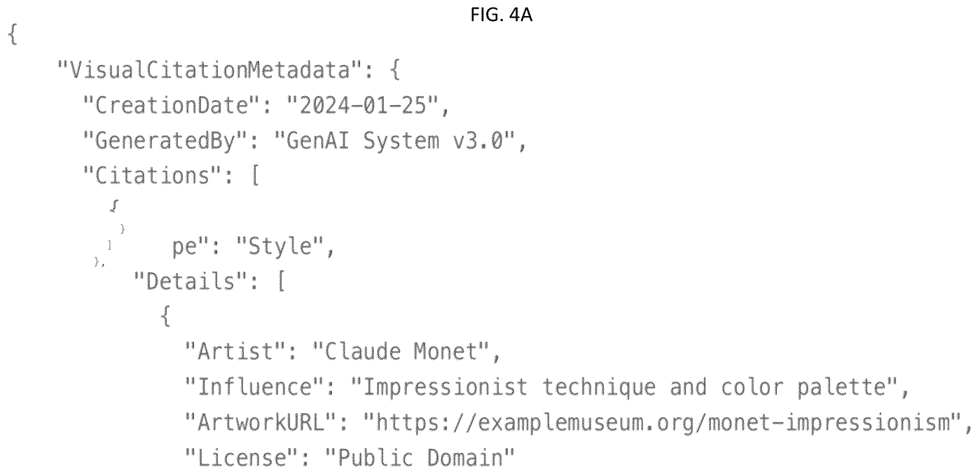

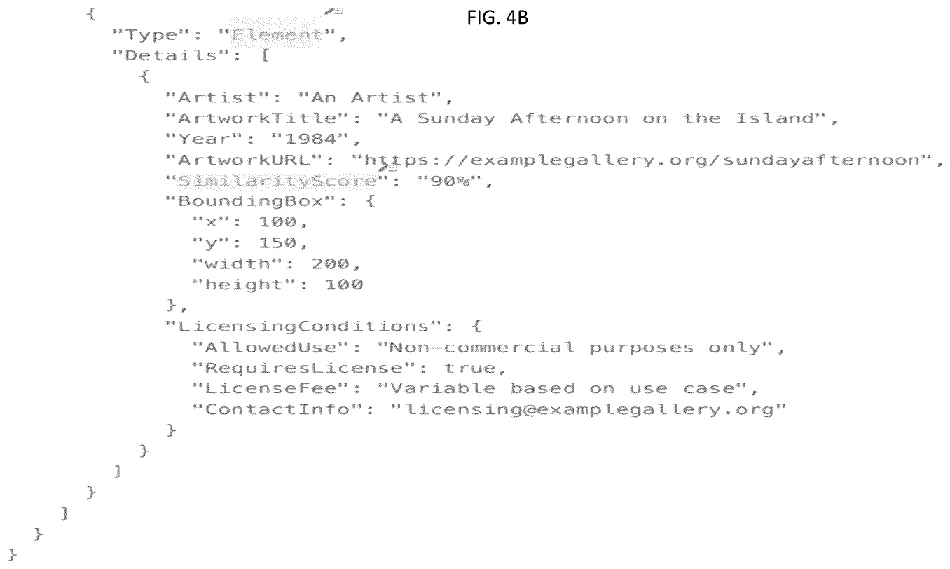

The citation may include, or may be limited to, a citation that specifies the origins of either the style or the elements of the output image, and may list the artists/author/source, and/or other citation information discussed herein. An example of code for visual citation is shown in FIG. 4A (e.g., style citation) and FIG. 4B (e.g., element or component citation). Thus, a visual citation metadata structure may be organized into two main citation types: 1. Style Citation: This section cites the overall style influences from artists or art movements on the output content. It may include the artist's name, the influence (e.g., technique, color palette), and a URL for further reference. This type of citation may acknowledge broader stylistic inspirations drawn from the works of noted artists. 2. Element Citation: This section may more specifically cite distinct elements within the image that closely resemble or are inspired by listed base content items. The element citation may provide detailed information, including the artist, the title of the artwork, and other such information, for example, as discussed above with respect to content item metadata, and may also include the similarity score. A citation may also identify the generative AI model and/or its creator(s) and/or its vendor(s) that created the output content.

Also contemplated is recursive chained citation. For example, a first user may generate a first output content that has a Monet style influenced (say 20%) by a first base content item (with other art elements mixed) and this first output content is added to the content database 105. Then, the generative AI system 103 creates a second output content that is a post-modern version. The citations for the second output content may include the full chain of base content used, including the first output content and the first base content item, similar to a real estate record.

As shown in FIG. 4B, the element citation may also include a bounding box that locates the base content item, or portion thereof, within the output. The bounding box coordinates (x, y, width, height) define the area of the image of the output content where the similarity is noted, offering visual acknowledgment of the specific inspiration.

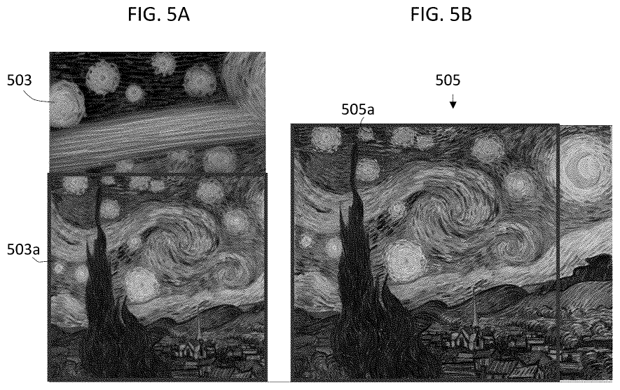

An example of a bounding box 503a showing an area of similarity is provided at FIG. 5A. FIG. 5A shown output content 503, in this case a painting, with bounding box 503a showing an area of similarity with base content 505. The style citation may include Van Gogh or post-impressionism or Van Gogh's post-impressionism. The element citation may identify “The Starry Night” (Dutch: “De sterrennacht”) and Vincent van Gogh as the artist.

As shown in FIG. 5B, according to an aspect of the disclosure, a citation may also include a reproduction of base content item 505, or a representation, illustration or portion of the base content item. In an embodiment, the citation provided to the user may also include a base content bounding box 505a that identifies an area in the base content item 505 that appears borrowed from, or similar to, the area of similarity 503a of the output content 503. That is, in an embodiment, the citation provided to the user may include a base content bounding box 505a that identifies an area in the base content item 505 that appears borrowed from, or similar to, the output content 503 even if no area of similarity 503a is identified in the output content 503. For example, a portion 505a of the base content item 505 may be determined to be excessively similar (for example, meeting or exceeding a threshold similarity of 70% or 80%) to the output content as a whole, or to a substantial portion of the output content. In some embodiments, a portion 505a of the base content item 505 may be determined to be excessively similar but not substantially more so than most other portions of the output content.

In addition, there could also be the license terms for each of the base content item, for example, drawn from the metadata in the content database 105. In the case of audio or video output content, the area of similarity may be identified as occurring starting at a particular time or frame and ending at a particular time or frame in the output content item.

In an embodiment, the system could evaluate the artists' preset licensing conditions. If allowed, the image can be used under specific terms, for example, with a license fee. Otherwise, the GenAI system may have to regenerate the image, possibly with automatically or manually modified prompt to specifically avoid generating the same element.

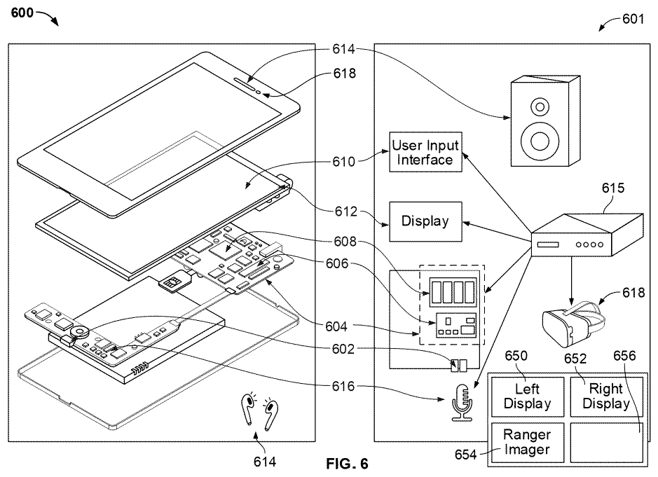

FIG. 6 illustrates an example of an implementation of the computing device 101, which may provide the citator 109 and other devices and system described herein. A circuit board may include control circuitry, processing circuitry, and storage (e.g., RAM, ROM, hard disk, removable disk, etc.). In some embodiments, the circuit board may include an input/output path for communicating with other devices and system as described herein. In an embodiment, some processes described with reference to the Generative AI system 103, such as computing embeddings, computing output content embedding, computing output content style, and/or computing output content features and the like may be performed by citator 109. Each device may receive content and data via input/output (I/O) path 612 that may comprise I/O circuitry (e.g., network card, or wireless transceiver). I/O path 612 may communicate over a local area network (LAN) or wide area network (WAN), for example, via Wi-Fi, Bluetooth, cellular or other wireless or wired connection.

Control circuitry may comprise processing circuitry 620 and storage 622 and may comprise I/O circuitry. Control circuitry may be used to send and receive commands, requests, and other suitable data using I/O path, which may comprise I/O circuitry, for example, for interacting with physical devices, visual elements and remote XR control devices, selecting or otherwise specifying policies for visual elements, determining likely objects of user interest, and for transmitting displays to be provided by the HMD of the XR HMD controller. I/O path may connect control circuitry (and specifically processing circuitry) to one or more communications paths (described below). I/O functions may be provided by one or more of these communications paths, but are sometimes shown as a single path to avoid overcomplicating the drawing.

Control circuitry may be based on any suitable control circuitry such as processing circuitry 620. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry executes instructions for various applications, including the XR application, stored in memory (e.g., storage 622). Specifically, control circuitry 608 may be instructed by the XR application to perform the functions discussed above and below. In some implementations, processing or actions performed by control circuitry may be based on instructions received from the XR application.

In client/server-based embodiments, control circuitry 608 may include communications circuitry suitable for communicating with other networks. The XR application may be implemented as software or as a set of executable instructions. The instructions for performing any of the embodiments discussed herein may be encoded on non-transitory computer-readable media (e.g., a hard drive, random-access memory on a DRAM integrated circuit, read-only memory etc.). For example, the instructions may be stored in storage, and executed by control circuitry of a device 600.

In some embodiments, one or more processes described herein may be a client residing on device 608 (e.g., device 600), and a server application may reside on the computing device. Control circuitry may include communications circuitry suitable for communicating with a server, and devices, a table or database server, or other networks or servers. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 622 that is part of control circuitry. As referred to herein, the phrase “electronic storage device” or “storage device” should be understood to mean any device for storing electronic data, computer software, or firmware, such as random-access memory, read-only memory, hard drives, optical drives, digital video recorders, solid state devices, quantum storage devices, gaming consoles, or any other suitable fixed or removable storage devices, and/or any combination of the same. Storage 622 may be used to store various types of content described herein. Nonvolatile memory may also be used (e.g., to launch a boot-up routine and other instructions).

Control circuitry 608 may include video generating circuitry and tuning circuitry. Control circuitry may also include scaler circuitry for upconverting and down converting content into the preferred output format of equipment 600. Control circuitry may also include digital-to-analog converter circuitry and analog-to-digital converter circuitry for converting between digital and analog signals. Video cameras may be integrated with the equipment or externally connected. One or more of cameras may be a digital camera comprising a charge-coupled device (CCD) and/or a complementary metal-oxide semiconductor (CMOS) image sensor. In some embodiments, one or more of cameras 656 may be dirtied at outside physical environment (e.g., two cameras may be pointed out to capture to parallax views of the physical environment).

The system described herein may be implemented using any suitable architecture. For example, it may be a stand-alone application wholly implemented on each one of user equipment device 600 and user equipment device 601. In such an approach, instructions of the application may be stored locally (e.g., in storage 608), and data for use by the application is downloaded on a periodic basis (e.g., from the edge service network, from an out-of-band feed, from an Internet resource, or using another suitable approach). Control circuitry may retrieve instructions of the application from storage 608 and process the instructions to provide XR generation functionality and perform any of the actions discussed herein. Based on the processed instructions, control circuitry may determine what action to perform when input is received from user input interface 610. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc. Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The user equipment devices may also communicate with each other directly through an indirect path via communication network.

Although communications paths are not always drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network. In an embodiment, a handheld device may be part of, or connected to the HMD 618 in a wired or wireless manner to control physical devices or visual elements.

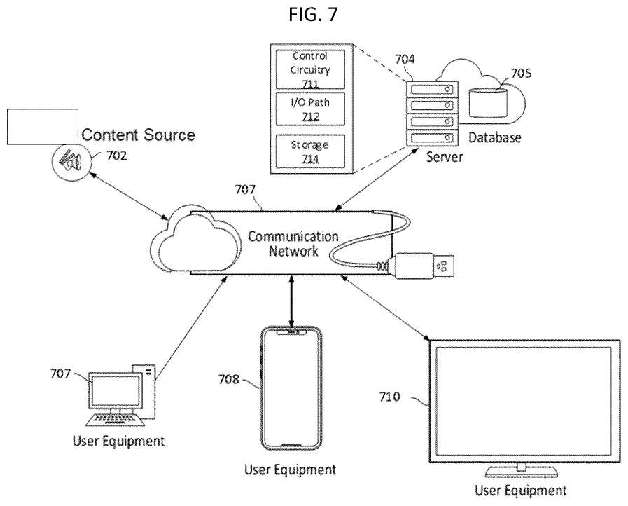

FIG. 7 is a diagram of an illustrative system 700 for citation generation and similarity remediation, in accordance with some embodiments of this disclosure. User equipment devices 707, 708, 710 may be coupled to communication network 706. Communication network 706 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 706.

System 700 may comprise media content source 702, one or more servers 704, and one or more edge computing devices 716 (e.g., included as part of an edge computing system, such as, for example, managed by mobile operator 206). In some embodiments, databases 105 and 107 of FIGS. 2 and 3, may be implemented as database 705 maintained at or otherwise associated with server 704, and/or at storage 722 and/or at storage of one or more of user equipment devices 707, 708, 710.

In some embodiments, server 704 may include control circuitry 711 and storage 714 (e.g., RAM, ROM, Hard Disk, Removable Disk, etc.). Storage 714 may store one or more databases. Server 704 may also include an input/output path 712. I/O path 712 may provide data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i9 processors) or multiple different processors (e.g., an Intel Core i7 processor and an Intel Core i9 processor). In some embodiments, control circuitry 711 executes instructions for an emulation system application stored in memory (e.g., the storage 714). Memory may be an electronic storage device provided as storage 714 that is part of control circuitry 711.

Edge computing device 716 may comprise control circuitry 718, I/O path 720 and storage 722, which may be implemented in a similar manner as control circuitry 711, I/O path 712 and storage 724, respectively of server 704. Edge computing device 716 may be configured to be in communication with one or more of user equipment devices 707, 708, 710 and server 704 over communication network 706, and may be configured to perform processing tasks in connection with ongoing processing of content. In some embodiments, a plurality of edge computing devices 716 may be strategically located at various geographic locations, and may be mobile edge computing devices configured to provide processing support for mobile devices at various geographical regions.

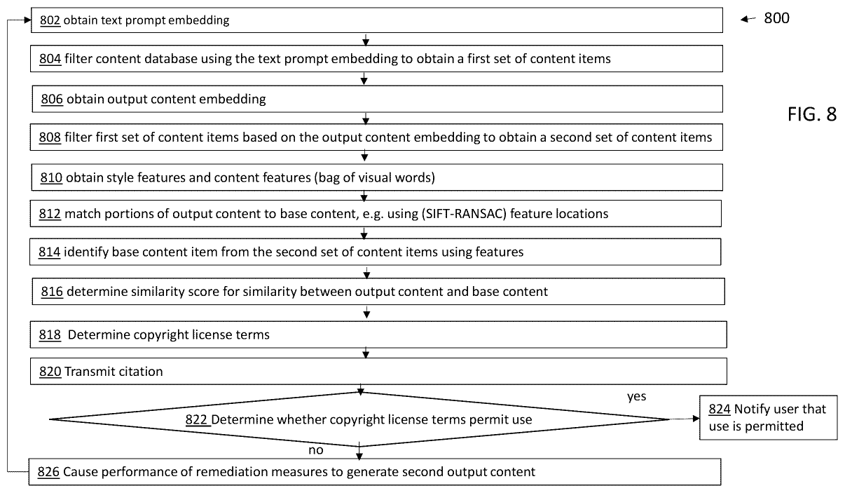

FIG. 8 is a flowchart showing a process 800 for determining a base content item in a citation for AI generate output content, according to an example of an implementation of the present disclosure. The process 800 may be implemented, in whole or in part, by the systems shown in FIGS. 6 and 7. One or more actions of the process 800 may be incorporated into or combined with one or more actions of any other process or embodiment described herein. The process 800 may be saved to a memory or storage (e.g., the storage of the system shown in FIG. 6) as one or more instructions or routines, which may be executed by any suitable device or system having access to the memory or storage to implement the process 800.

At 802, a text prompt embedding may be obtained based on the text prompt received by the generative AI 103 to generate output content. In an embodiment, the text prompt may be provided to the citator 109 simultaneously or in real-time with the providing of the text prompt to the generative AI 103 that creates the output content, and the citator 109 may generate the text prompt embedding therefrom. In an embodiment, the generative AI 103 may send to the citator 109 the text prompt embedding that the generative AI 103 generates from the input text prompt.

At 804, the database 105 may be filtered using the text prompt embedding to generate a first list or set of content items. This step may be conducted simultaneously or in parallel with the generative AI 103 creating the output content. Based on the output content created by the generative AI 103, at 806 an output content embedding may be generated and provided to the citator 109. In an example, the AI 103 may transmit the output content to the citator 109 and the citator may generate the output content embedding based on the received output content.

At 808, the first list of content items may be filtered using the received or obtained output content embedding. The first content item list is thus further filtered to yield a second content item list or set that may then be utilized to more efficiently and quickly identify relevant base content item(s).

At 810, style features and content or component features (e.g., SIFT features and/or a bag of visual words) may be obtained based on the output content. These features may be used to identify portions of the content items in the second content item list that are similar to portions of the output content. In an embodiment, this process may entail matching portions or features between the output content and the base content, e.g., using SIFT-RANSAC feature matching at 812. NMS may also be used as part of this process to identify and accurately localize unique instances of similar or matching features. At 814, the base content item(s) to be used for the citation is/are thus identified. In an implementation, similar portions of these content items may be scored to determine one or more base content items that are most similar, as shown at 816.

At 818, the citator 109 may determine copyright license or other usage terms. For example, metadata stored in association with the base content item may indicate what types of uses may be permitted, whether the base content item and/or the work that the base content item reproduces or represents is/are subject to copyright and/or to trademark/trade dress and/or other restrictions, for example, sui generis intellectual property protection.

At 820, the citator 109 may transmit the citation to the generative AI system 103. In this example, the citation includes metadata indicating the copyright or other usage terms.

At 822, in this example, the generative AI system determines whether copyright license or other usage terms for the base content item permit use. If the license terms permit use, then at 824, the generative AI system 103 may notify the user 301 that use, or a specific type of use, of the output content is permitted. The output content may then be provided to the user 301. In an implementation, the citation may be provided with the output content, such as via a watermark. In an implementation, one or more watermarks may be added to the output content indicating the base content item and/or the work that the base content item reproduces or represents even if the copyright license terms permit the contemplated use. In this way, for example, moral rights of attribution to the author/source may be respected.

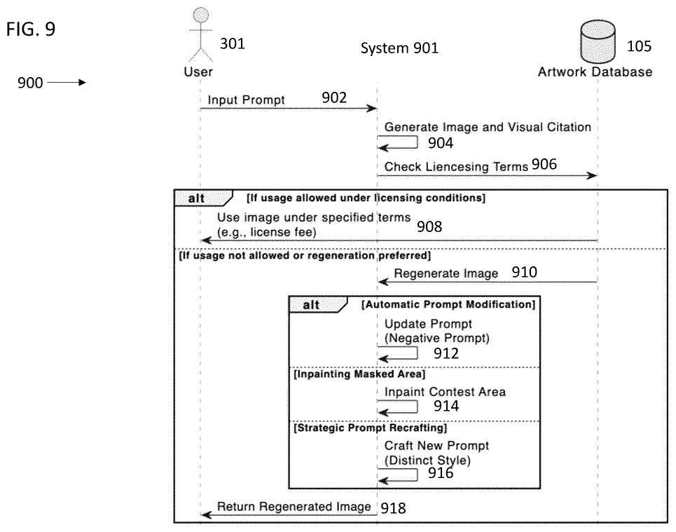

On the other hand, if the copyright license terms of the base content item do not permit use of the type that creates the output content, then remediation measures may be caused, as shown at 826 and as described elsewhere herein, such as in FIG. 9. The output content may be altered or regenerated. Based on the remediation measures taken, an altered output content may be generated. In response to the altered output content, a new citation be necessary or desired. Accordingly, the method 800 may iterate through one or more of the previous method steps to identify base content item(s) based on the altered output content.

In an embodiment, the database 105 may be notified or updated to include data that the base content item has been cited in connection with the output content. For example, metatdata may be stored in association with the base content item indicating the output content for which it was cited. In an embodiment, the content source 303, for example, the artist, may be notified that the base content item has been cited in connection with the output content. For example, the underlying work of which the base content item is a reproduction of may be identified together with an indication of the database 105 in which the base content item is stored and the output content for which it was cited. In an embodiment, the actual output content may not be known to the citator 109, and a reference identifier to the output content and/or to the generative AI system 103 is determined and stored in association with the relevant base content item.

FIG. 9 is a flowchart showing a process 900 for determining restriction on the base content item cited and for taking remediation measures. The process 900 may be implemented, in whole or in part, by the systems shown in FIGS. 6 and 7. One or more actions of the process 900 may be incorporated into or combined with one or more actions of any other process or embodiments described herein. The process 900 may be saved to a memory or storage (e.g., the storage of the system shown in FIG. 6) as one or more instructions or routines, which may be executed by any suitable device or system having access to the memory or storage to implement the process 900.

According to an aspect of the disclosure, upon generating visual citations, the system may have an additional application to handle instances where an AI-generated image exhibits significant element similarity to copyrighted artworks, based on the visual citation. This application may be integrated with the citator 109 and may determine the artists' predefined licensing conditions in the base content item, determining the permissibility and terms of use for each influenced element within the generated images.

As shown in FIG. 9, according to a method 900, at 902 the user may input a prompt to the system 901. System 901 may include the Generative AI system 103 and the citator 109, or otherwise performed functions thereof. For example, the citator 109 may be a server that provides the processing associated therewith as a separate system from the Generative AI system 103. In some embodiments, the Generative AI system 103 and the citator 109 may be integrated into one system that both creates the output content and the citation, as well as the other processing described herein.

At 904, the system 901 creates the output content, and generates or otherwise receives or accesses a citation for the output content, and may at that time transmit the citation to the user or may transmit it to the user subject to the following processing operations. In an embodiment, a user may determine that the output content created by the ML model seems too similar to one or more base content items, which may or may not be identified in the citation, and may request or initiate remediating action as described herein.

At 906, the system 901 may check the terms of a copyright license, such as in the metadata stored or associated with the base content item in the database 105. As discussed, this step may include checking the relevant jurisdiction's copyright laws to determine that the base content item has passed into the public domain or checking the date on which the base content item passes or passed into the public domain. In an embodiment, similarity may be ignored, or a higher threshold of similarity may be considered, if the base content item is determined to have passed into the public domain. At 908, the system 901 may notify the user of the licensing terms, and may notify the user of a licensing fee, needed attribution or citation, or other conditions required for using the output content. As discussed, the system 901 may also insert a watermark on the output content, and may show a degree of similarity between the output content and the base content item. The system 901 may also specify an area of similarity, and the degree of similarity of the area of similarity may also be shown. The user may also be provided with contact information for the owner of the copyright.

At 910, the system 901 may regenerate the output content item, for example, if no permission was provided with the base content item in the database 105, or if permission was not obtained for using the base content item. As discussed, the system may determine not to output the content generated by the ML model if the system 901 determines that no permission has been granted by the copyright owner for using the base content item.

As shown at 912, regenerated output may be obtained by providing an updated prompt to the ML model, such as an updated prompt with exclusion or positive term(s). The updated prompt may be provided automatically, for example, the system 901 may automatically update the prompt to exclude a visual element or feature of the base content item, such as by adding a negative term that describes the element to be avoided to yield a regenerated image that does not include the excluded element. This remediation may be triggered programmatically by an API when the similarity score meets a similarity threshold. The amount of remediation may be driven by the similarity score, for example, the higher the score or the greater the similarity, the more alteration to the output content. The output content may be provided to the user together with a notification that the output content is excessively similar to, a base content item, and that a regenerated output content will be provided. Or, the reformulated prompt may be a manual prompt modification performed by the user 301 in response to a request by the system 901 to add an exclusion term to the prompt. For example, a Boolean term, such as “but not” or “not near” or the like may be followed by the term to be excluded and input to the generative ML model for creating regenerated output content.

In an embodiment, it may be desired to increase the similarity of the output content to the base content item, such as if the source 303 (copyright owner, base content item creator, etc.) grants permission for using the output content. For example, the user 301 may be shown the output content and the citation identifying the base content item, and decide that she really likes the base content item as reflected in the output content. The user 301 may request permission from the source 303 (for example, negotiate a license), or otherwise obtain permission for use. In response, the generative AI model 103 may increase the style and/or features and/or components from the base content item that are created as part of the revised output content. For example, the user 301 may be prompted to select whether preference is for the style and/or features and/or components of the base content item that the user wants to represent more of in the output content.

Removing or inpainting the area of similarity, or more than one such area, from the output content may also be performed, an example of which is illustrated and described above in relation to FIG. 2. In an embodiment, output content modified or regenerated in one or more of these ways may be provided without outputting a citation to a base content item.

At 914, the system 901 may apply inpainting techniques to the area of similarity as part of the process for generating output content item that is provided to the user. The area of similarity may be blocked or obscured or edited out of the output content, or may be altered in other ways, for example, by changing color patterns, or resizing and repositioning elements therein, or by moving the area to a different portion of the output content in combination with other inpainting techniques. A style of the area of similarity may be changed so that a different look is obtained. Also, the ML model may be prompted to substitute another output content for the area of similarity.

At 916, a new text prompt may be (automatically) generated by the system. In an embodiment, the new text prompt may be limited to or focused on modifying the area of similarity. In another embodiment, a new text prompt may be generated if the similarity detected is not localized to a particular area of similarity or if there are too many areas of similarity for inpainting or for minor modification of the prompt using an excluding term. The system 901 may predict what terms are likely to have caused the generative ML model to create output content that is excessively or undesirably similar to the base content item, and then change or omit those terms from the re-crafted input prompt. Then the regenerated output content may be provided to the user.

In an embodiment, the system 901 may leverage metadata associated with the base content item, including details about the author and style to craft a new prompt. This new prompt may be formulated to seek inspiration from styles that are distinct from or inversely related to the identified artist, so that the generative ML model creates output content that diverges from the base content item's visual-cited style or its elements.

Metadata associated with the base content item may be retrieved and used, directly or after further processing, to generate the new text prompt. For example, if the base content item is a painting, the metadata may indicate the style as Rococo or the period of the painting as 18^{th} Century and the second prompt may indicate a term of exclusion to exclude Rococo and/or 18^{th} Century styles. Or, based on the metadata, the artist who created the base content item may be identified and the second prompt may be more specifically tailored to exclude this artist. Similarly, based on the metadata, the system may select a style, period or artist other than those corresponding to the base content item and then add the selected style, period or artist to the second prompt to generate the second output content. For example, the system may select a style, period or artist that is similar to that of the base content item and may select an artist with a style and of a period similar to the first artist identified for the base content item. In this way, the new output content may be similar to the first output content but avoid similarity with the base content item first cited and thus the new output content to be generated may be consistent with the general direction of the original text prompt. Similarly, the system may exclude from the new prompt a year of creation of the particular base art cited, or the title of the base art cited and thus avoid excessive similarity in the new output content while aiming to maintain the original spirit of the first output content.

At 918, regenerated output content may be provided as the output. The regenerated output may be a version of the original output content subjected to repainting, may be a new output content created based on a modified text prompt, for example, modified by the addition of a negative prompt, and/or the regenerated prompt may have been created using a new text prompt, for example, a new text prompt with new terms substituted for terms used in the original text prompt.

One or more actions of the methods 300, 800-900 may be incorporated into or combined with one or more actions of any other process or embodiments described herein. These and other methods described herein, or portions thereof, may be saved to a memory or storage (e.g., of the systems shown in FIG. 6) or locally as one or more instructions or routines, which may be executed by any suitable device or system having access to the memory or storage to implement these methods.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be affected to the particular embodiments by those of skill in the art without departing from the scope of the present application, which is defined solely by the claims appended hereto.

1. A method of determining a citation for output content generated by a trained generative machine learning model (ML model), the method comprising:
determining a first set of one or more content items by filtering content items in a content database based on a text prompt embedding, wherein the text prompt embedding is generated based on a text prompt used by the ML model to generate the output content;
determining a second set of one or more content items by filtering the first set of content items using an output content embedding, wherein the output content embedding is generated based on the output content;
identifying a base content item for the output content by filtering the second set of content items using a component feature to identify at least one corresponding region between the output content and the base content item, wherein the component feature is generated based on the output content; and
transmitting a citation for the output content based on the identified base content item.

2. The method of claim 1, wherein the output content comprises an image generated by the ML model.

3. The method of claim 1, wherein the content items of the content database are clustered by content style;
wherein the determining the second set of content items comprises filtering the first set of content items based on the clustered content items and using a style embedding generated based on the output content and a component embedding generated based on the output content.

4. The method of claim 1, wherein the identifying the base content item further comprises:
matching, using a scale-invariant feature transform (SIFT) process, the base content item and the output content; and
obtaining matched SIFT locations in the output content to generate a mask of matched features.

5. The method of claim 4, wherein based on the obtained matched SIFT locations, the citation indicates a first portion of the output content of greater similarity to the base content item than a second portion of the output content item.

6. The method of claim 1, wherein the citation comprises attribution information indicating a title, a creator, or a source of the base content item.

7. The method of claim 1, wherein the citation comprises a similarity score indicating a degree of similarity between the output content and the base content item.

8. The method of claim 1, wherein the citation comprises copyright restriction information for the base content item.

9. The method of claim 1, wherein the citation comprises a human-perceptible watermark provided on the output content indicating the base content or indicating ownership of the base content.

10. The method of claim 1, wherein the citation comprises a machine-detectable watermark imperceptible to humans using a naked eye, and provided on the output content indicating the base content or indicating a source of the base content.

11-22. (canceled)

23. A system of determining a citation for output content generated by a trained generative machine learning model (ML model), the system comprising:
a memory; and
control circuitry configured:
to determine a first set of one or more content items by filtering content items in a content database based on a text prompt embedding, wherein the text prompt embedding is generated based on a text prompt used by the ML model to generate the output content;
to determine a second set of one or more content items by filtering the first set of content items using an output content embedding, wherein the output content embedding is generated based on the output content, and to store the second set of one or more content items in the memory;
to identify a base content item for the output content by filtering the second set of content items using a component feature to identify at least one corresponding region between the output content and the base content item, wherein the component feature is generated based on the output content; and
to transmit a citation for the output content based on the identified base content item.

24. The system of claim 23, wherein the output content comprises an image generated by the ML model.

25. The system of claim 23, wherein the content items of the content database are clustered by content style;
wherein the determining the second set of content items comprises filtering the first set of content items based on the clustered content items and using a style embedding generated based on the output content and a component embedding generated based on the output content.

26. The system of claim 23, wherein the identifying the base content item further comprises:
matching, using a scale-invariant feature transform (SIFT) process, the base content item and the output content; and
obtaining matched SIFT locations in the output content to generate a mask of matched features.

27. The system of claim 26, wherein based on the obtained matched SIFT locations, the citation indicates a first portion of the output content of greater similarity to the base content item than a second portion of the output content item.

28. The system of claim 23, wherein the citation comprises attribution information indicating a title, a creator, or a source of the base content item.

29. The system of claim 23, wherein the citation comprises a similarity score indicating a degree of similarity between the output content and the base content item.

30. The system of claim 23, wherein the citation comprises copyright restriction information for the base content item.

31. The system of claim 23, wherein the citation comprises a human-perceptible watermark provided on the output content indicating the base content or indicating ownership of the base content.

32. The system of claim 23, wherein the citation comprises a machine-detectable watermark imperceptible to humans using a naked eye, and provided on the output content indicating the base content or indicating a source of the base content.

33-109. (canceled)
